(19) United States
(12) Patent Application Publication
(10) Pub. No.: US 2023/0036056 A1
(43) Pub. Date: Feb. 2, 2023

(54) VEHICLE AND CONTROL METHOD THEREOF

(71) Applicants: HYUNDAI MOTOR COMPANY, Seoul (KR); KIA CORPORATION, Seoul (KR)

(72) Inventor: Hyung Jun LIM, Gyeonggi-do (KR)

(73) Assignees: Hyundai Motor Company, Seoul (KR); KIA CORPORATION, Seoul (KR)

(21) Appl. No.: 17/858,392

(22) Filed: Jul. 6, 2022

(30) Foreign Application Priority Data
Jul. 29, 2021 (KR) 10-2021-0099822

(51) Int. Cl. B60W 60/00; G01C 21/34

(52) U.S. Cl. CPC B60W 60/00253; G01C 21/3461; B60W 2756/10; B60W 2555/20; B60W 2556/50; B60W 2420/42; B60W 2420/52

(57) ABSTRACT

A vehicle includes a navigation configured to output navigation information; and a controller configured to receive a requested stopping location of the vehicle for a passenger to get on or off, to determine a stopping location of the vehicle based on the navigation information and information on a designated no-stopping zone, in response to the receiving of the requested stopping location, and to control the vehicle to head to the determined stopping location.

### CROSS-REFERENCE TO RELATED APPLICATION

The present application claims priority to Korean Patent Application No. 10-2021-0099822, filed on Jul. 29, 2021, the entire contents of which is incorporated herein for all purposes by this reference.

### BACKGROUND OF THE PRESENT DISCLOSURE

### Field of the Present Disclosure

The present disclosure relates to a vehicle and a control method thereof.

### Description of Related Art

The likelihood of a traffic accident when getting on or off a vehicle may vary depending on a parking/stopping location of the vehicle.

For example, when a passenger gets on or off a vehicle while the vehicle is stopped or parked in a no-parking/stopping zone such as a pedestrian walkway, road in front of a fire hydrant, and/or an intersection, a vehicle accident is more likely to occur, compared to when getting on or off while the vehicle is stopped in a parking area.

Furthermore, when a passenger gets on or off a vehicle while the vehicle is stopped or parked in a no-parking/stopping zone such as a pedestrian walkway, road in front of a fire hydrant, and/or an intersection, inconvenience to nearby vehicles and pedestrians may be caused.

Conventionally, a function of providing a warning as another vehicle approaches when stopping or parking a vehicle, a child lock function of controlling rear doors at a driver's seat, and the like, have been used to reduce occurrence of a traffic accident risk when getting on or off the vehicle.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle and a control method thereof which may control the vehicle to identify a location where the vehicle may be stopped or parked.

For instance, the vehicle and the control method thereof may allow a vehicle door to be open based on an identification of a location where the vehicle may be stopped or parked in consideration of a surrounding environment of the vehicle, so that a passenger may get on or off without a risk of a traffic accident.

For instance, the vehicle and the control method thereof may minimize obstruction to other vehicle's driving and pedestrian's walking due to stopping or parking of the vehicle and/or getting on or off, by inducing the vehicle to stop outside a no-parking/stopping zone such as a pedestrian walkway, road in front of a fire hydrant, an intersection and/or a school zone.

Additional aspects of the present disclosure will be set forth in part in the description which follows, and in part, will be obvious from the description, or may be learned by practice of the present disclosure.

According to an aspect of the present disclosure, there is provided a vehicle, including: a navigation configured to output navigation information; and a controller configured to receive a requested stopping location of the vehicle for a passenger to get on or off, to determine a stopping location of the vehicle based on the navigation information and information on a designated no-stopping zone, in response to the receiving of the requested stopping location, and to control the vehicle to head to the determined stopping location.

The controller is configured to identify whether the requested stopping location is included in the designated no-stopping zone based on the navigation information and the information on the designated no-stopping zone, and when the requested stopping location is included in the designated no-stopping zone, determine at least one location outside of the designated no-stopping zone and located within a predetermined distance range from the requested stopping location, as the stopping location of the vehicle, based on the navigation information.

When the requested stopping location is included in the designated no-stopping zone, the controller is configured to control a communicator of the vehicle to transmit information on a suggestion of the determined stopping location as the stopping location of the vehicle, or control an outputter of the vehicle to output the information on the suggestion of the stopping location of the vehicle as the determined stopping location, and control the vehicle to head to the determined stopping location according to reception of approval information to the suggestion of the stopping location of the vehicle through the communicator or an inputter of the vehicle.

The controller is configured to determine the requested stopping location as the stopping location of the vehicle, when the requested stopping location is not included in the designated no-stopping zone.

The vehicle further includes a detector configured to obtain surrounding information of the vehicle, wherein the controller is configured to identify whether the requested stopping location is included in the designated no-stopping zone, further based on the surrounding information obtained through the detector.

The controller is configured to determine a location where the passenger is able to get on or off the vehicle based on the surrounding information obtained through the detector, when the vehicle arrives at a predetermined distance from the determined stopping location, and control the communicator of the vehicle to transmit information on the location where the passenger is able to get on or off the vehicle, or control the outputter of the vehicle to output the information on the location where the passenger is able to get on or off the vehicle.

The controller is configured to control the vehicle to stop at the location where the passenger is able to get on or off the vehicle, according to reception of approval information to the information on the location where the passenger is able to get on or off the vehicle through the communicator or an inputter of the vehicle.

The controller is configured to re-determine the location where the passenger is able to get on or off the vehicle according to the surrounding information obtained through the detector and reception of disapproval information to the location where the passenger is able to get on or off the vehicle through the communicator or an inputter of the vehicle.

The detector includes at least one of a camera, a radar and a Light Detection and Ranging (LiDAR).

The vehicle further includes a detector configured to obtain surrounding information of the vehicle; and a driving portion configured to allow a door of the vehicle to be open by a rotation force of a motor in a first direction, wherein, when the vehicle is stopped at the determined stopping location, the controller is configured to detect whether an object approaches the vehicle and whether the passenger opens the door, based on the surrounding information obtained through the detector, and when the approaching of the object to the vehicle and the opening of the door are detected, control the driving portion to generate a rotation force in a second direction opposite to the first direction.

The information on the designated no-stopping zone includes information indicating that at least one of an intersection, a pedestrian walkway, a location where a fire hydrant is placed, or a school zone is located within a predetermined distance.

According to an aspect of the present disclosure, there is provided a method of controlling a vehicle, the control method including: receiving a requested stopping location of the vehicle for a passenger to get on or off, determining a stopping location of the vehicle based on navigation information of the vehicle and information on a designated no-stopping zone, in response to the receiving of the requested stopping location, and controlling the vehicle to head to the determined stopping location.

The determining of the stopping location of the vehicle includes identifying whether the requested stopping location is included in the designated no-stopping zone based on the navigation information and the information on the designated no-stopping zone, and when the requested stopping location is included in the designated no-stopping zone, determining at least one location outside of the designated no-stopping zone and located within a predetermined distance range from the requested stopping location, as the stopping location of the vehicle, based on the navigation information.

The determining of the stopping location of the vehicle includes, when the requested stopping location is included in the designated no-stopping zone, transmitting information on a suggestion of the determined stopping location as the stopping location of the vehicle to an external device, or outputting the information on the suggestion of the determined stopping location as the stopping location of the vehicle, and the controlling of the vehicle to head to the determined stopping location is performed according to reception of approval information to the suggestion of the stopping location of the vehicle.

The determining of the stopping location of the vehicle includes determining the requested stopping location as the stopping location of the vehicle, when the requested stopping location is not included in the designated no-stopping zone.

The identifying of whether the requested stopping location is included in the designated no-stopping zone is performed further based on surrounding information of the vehicle, the surrounding information being obtained through a detector that obtains the surrounding information of the vehicle.

The control method may further include determining a location where the passenger is able to get on or off the vehicle based on the surrounding information obtained through the detector, when the vehicle arrives at a predetermined distance from the determined stopping location, and transmitting information on the location where the passenger is able to get on or off the vehicle to the external device, or outputting the information on the location where the passenger is able to get on or off the vehicle.

The control method may further include controlling the vehicle to stop at the location where the passenger is able to get on or off the vehicle, according to reception of approval information to the information on the location where the passenger is able to get on or off the vehicle.

The control method may further include re-determining the location where the passenger is able to get on or off the vehicle, according to the surrounding information obtained through the detector and reception of disapproval information to the location where the passenger is able to get on or off the vehicle.

The control method includes: when the vehicle is stopped at the determined stopping location, detecting whether an object approaches the vehicle and whether the passenger opens the door, based on surrounding information obtained through a detector, and when the approaching of the object to the vehicle and the opening of the door are detected, controlling a rotation force of a motor to be generated in a second direction opposite to a first direction, the door being open by a rotation force of the motor in the first direction.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a vehicle according to an exemplary embodiment of the present disclosure;

FIG. 2 is a block diagram illustrating a camera and a radar included in a vehicle according to an exemplary embodiment of the present disclosure;

FIG. 3 is a block diagram illustrating a vehicle according to an exemplary embodiment of the present disclosure;

FIG. 4 is a flowchart illustrating operations of a vehicle according to an exemplary embodiment of the present disclosure;

FIG. 5A and FIG. 5B are flowcharts illustrating operations of a vehicle according to an exemplary embodiment of the present disclosure; and

FIG. 6A, FIG. 6B and FIG. 6C are diagrams illustrating operations of a vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Like reference numerals throughout the specification denote like elements. Also, the present specification does not describe all the elements according to various exemplary embodiments of the present disclosure, and descriptions well-known in the art to which the present disclosure pertains or overlapped portions are omitted. The terms such as “˜˜part”, “˜˜device”, “˜˜module”, and the like may refer to a unit of processing at least one function or act. For example, the terms may refer to at least process processed by at least one hardware or software. According to various exemplary embodiments of the present disclosure, a plurality of “˜parts”, “˜˜devices”, or “˜modules” may be embodied as a single element, or a single of “˜part”, “˜˜device”, or “˜module” may include a plurality of elements.

It will be understood that when an element is referred to as being “˜connected” to another element, it may be directly or indirectly connected to the other element, wherein the indirect connection includes “˜connection” via a wireless communication network.

It will be understood that the terms “˜include” when used in the exemplary embodiment, specify the presence of stated features, integers, steps, operations, elements, and/or components, but do not preclude the presence or addition of one or more other features, integers, steps, operations, elements, components, and/or groups thereof.

It will be understood that, although the terms first, second, etc. may be used herein to describe various elements, these elements should not be limited by these terms.

It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

Hereinafter, an operation principle and embodiments will be described in detail with reference to the accompanying drawings.

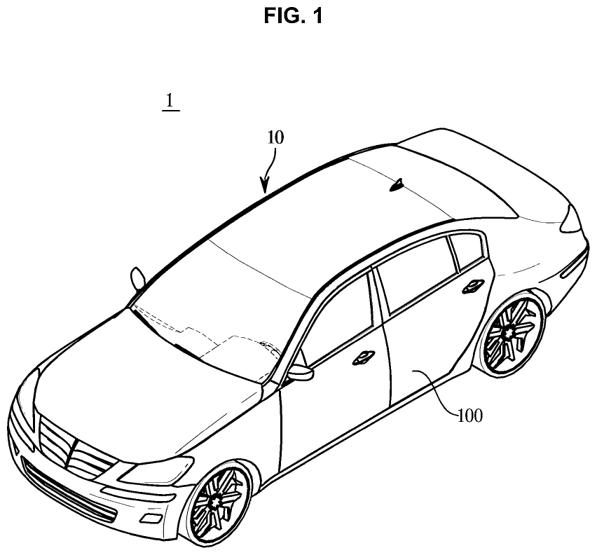

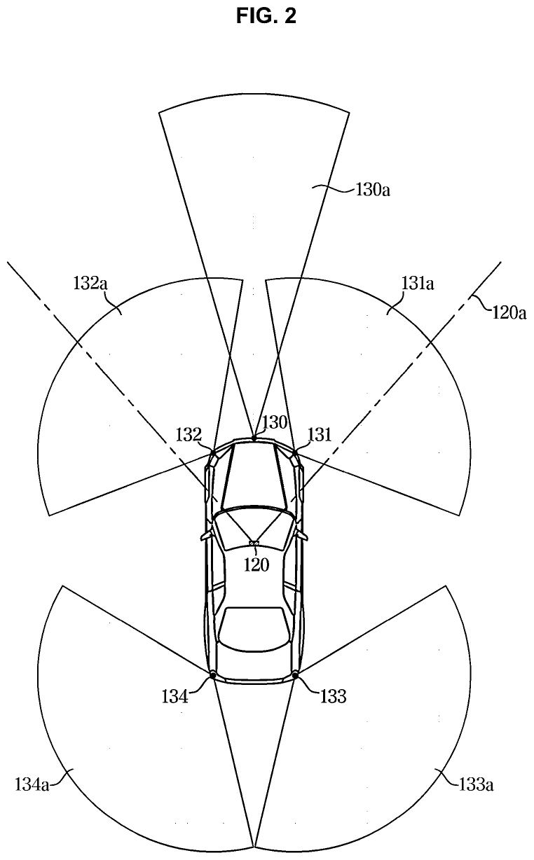

FIG. 1 is a diagram illustrating a vehicle according to an exemplary embodiment of the present disclosure. FIG. 2 is a block diagram illustrating a camera and a radar included in a vehicle according to an exemplary embodiment of the present disclosure.

The vehicle 1 is a machine that runs on roads to transport people or cargo. Here, the vehicle 1 refers to a vehicle driven by an individual in general, but may include a taxi where a passenger has to pay a taxi fare, a driverless taxi, and the like.

Referring to FIG. 1, doors 100 that shield interior of the vehicle 1 from an outside may be provided in a main body 10 that defines an appearance of the vehicle 1.

The doors 100 may be movably provided on left and right sides of the vehicle 1 to allow a user to get in the vehicle 1 when open, and shield the interior of the vehicle 1 from the outside thereof when closed.

Meanwhile, although not illustrated, an internal door handle of the vehicle 1 is provided inside the vehicle 1 to open the door 100 by a user. In the present instance, the internal door handle may be a handle operated in a pulling manner to open or close the door 100 by a user, or a button type door handle to automatically open or close the door 100 by pressing a button.

Referring to FIG. 2, a camera 120 and/or radars 130, 131, 132, 133 and 134 configured for securing a field of view of the vehicle 1 may be mounted on the main body 10 of the vehicle 1.

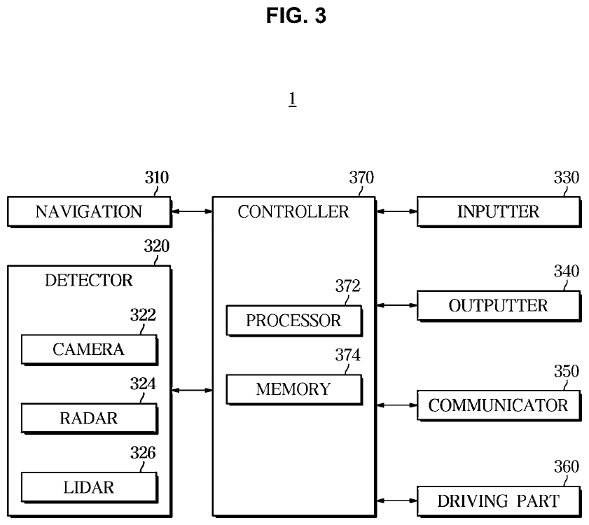

The camera 120 may include at least one lens and at least one image detector configured to generate image data of field of view of the vehicle 1 and transmit the image data to a controller (refer to 370 of FIG. 3, which will be described later).

As shown in FIG. 2, the camera 120 may have a field of view 120a facing a front of the vehicle 1. For example, the camera 120 may be mounted on a front windshield of the vehicle 1, and be a front camera for surround view monitor.

The camera 120 may photograph the front of the vehicle 1 and obtain image data of the front of the vehicle 1. For instance, the image data of the front of the vehicle 1 may include information related to an object located in front of the vehicle 1 such as other vehicles, pedestrians, cyclists, lanes, curbs, guard rails, street trees, and/or street lights, etc. Hereinafter, the object described above may be referred to as simply an object and/or an obstacle.

Meanwhile, although not illustrated in FIG. 2, the camera 120 may include a rear camera configured for securing a field of view facing the rear of the vehicle 1 and/or a side camera configured for securing a field of view facing sides of the vehicle 1.

The rear camera may be mounted on a rear windshield of the vehicle 1. The rear camera photographs the rear of the vehicle 1 and obtain image data of the rear of the vehicle 1. The image data of the rear of the vehicle 1 including information related to an object that approaches from behind, e.g., route information of other vehicle, may be transmitted to the controller 370. In the present instance, the controller 370 may predict which side of the vehicle 1 another vehicle will approach based on the route information. When it is predicted that the other vehicle approaches one of the doors 100, the controller 370 controls a driving portion 360 to be described later.

The side camera may be mounted on B pillar of the vehicle 1. The side camera photographs the sides of the vehicle 1 and obtain image data of the sides of the vehicle 1. The image data of the sides of the vehicle 1 may be used to detect a plurality of vehicles parked on the sides of the vehicle 1, and obtain information on a distance between each of the vehicles parked.

As shown in FIG. 2, the radars 130, 131, 132, 133 and 134 may include a first radar 130 and/or at least one second radars 131, 132, 133 and 134.

As shown in FIG. 2, the first radar 130 may have a field of sensing 130a facing the front of the vehicle 1. For example, the first radar 130 may be mounted on a grille or bumper of the vehicle 1.

The first radar 130 may include a transmission antenna (or a transmission antenna array) that emits a transmission wave toward the front of the vehicle 1, and a receiving antenna (or a receiving antenna array) that receives a reflection wave reflected by the object. The first radar 130 may obtain detection data from the transmission wave transmitted by the transmission antenna and the reflection wave received by the receiving antenna. The detection data may include distance information and speed information related to other vehicles, pedestrians, or cyclists located in front of the vehicle 1. The first radar 130 may determine a relative distance to the object based on a phase difference (or a time difference) between the transmission wave and the reflection wave. Also, the first radar 130 may determine a relative speed of the object based on a frequency difference between the transmission wave and the reflection wave.

The second radars 131, 132, 133 and 134 may include a first corner radar 131 mounted on a front right side of the vehicle 1, a second corner radar 132 mounted on a front left side of the vehicle 1, a third corner radar 133 mounted on a rear right side of the vehicle 1 and/or a fourth corner radar 134 mounted on a rear left side of the vehicle 1.

As shown in FIG. 2, the first corner radar 131 may have a field of sensing 131a facing the front right side of the vehicle 1. For example, the first corner radar 131 may be mounted on a right side of a front bumper of the vehicle 1. The second corner radar 132 may have a field of sensing 132a facing the front left side of the vehicle 1. For example, the second corner radar 132 may be mounted on a left side of the front bumper of the vehicle 1. The third corner radar 133 may have a field of sensing 133a facing the rear right side of the vehicle 1. For example, the third corner radar 133 may be mounted on a right side of a rear bumper of the vehicle 1. The fourth corner radar 134 may have a field of sensing 134a facing the rear left side of the vehicle 1. For example, the fourth corner radar 134 may be mounted on a left side of the rear bumper of the vehicle 1.

Each of the first to fourth corner radars 131, 132, 133 and 134 may include a transmission antenna and a receiving antenna. The first to fourth corner radars 131, 132, 133 and 134 may obtain first to fourth corner detection data, respectively. The first corner detection data may include distance information and speed information related to an object located on the front right side of the vehicle 1. The second corner detection data may include distance information and speed information related to an object located on the front left side of the vehicle 1. The third corner detection data may include distance information and speed information related to an object located on the rear right side of the vehicle 1, and the fourth corner detection data may include distance information and speed information related to an object located on the rear left side of the vehicle 1.

Each of the first to fourth corner radars 131, 132, 133 and 134 may transmit the first to fourth corner detection data to the controller 370.

Meanwhile, although not illustrated in FIG. 2, a Light Detection and Ranging (LiDAR) to have an external field of view of the vehicle 1 may be mounted on the main body 10 of the vehicle 1 and obtain LiDAR data. For instance, the LiDAR may be mounted on the front bumper, radiator grille, hood, roof, doors, side mirrors, tailgate, trunk lid or fender of the vehicle 1.

Meanwhile, the vehicle 1, the doors 100, the camera 120 and the radars 130, 131, 132, 133 and 134 mounted on the vehicle 1 illustrated in FIG. 1 and FIG. 2 is an exemplary embodiment of the present disclosure, and a shape, configuration and arrangement thereof may be changed.

FIG. 3 is a block diagram illustrating the vehicle 1 according to an exemplary embodiment of the present disclosure.

Referring to FIG. 3, the vehicle 1 may include a navigation 310, a detector 320, an inputter 330, an outputter 340, a communicator 350, the driving portion 360 and/or the controller 370.

The navigation 310 may output navigation information. The navigation information may include map information (also referred to as a map) and route information to provide a route to a destination input by a driver of the vehicle 1.

The navigation 310 may identify location information, driving environment information, and the like of the vehicle 1 by matching location coordinates of the vehicle 1 identified through a satellite signal to a map stored in a memory in advance, may generate the route information. For example, the navigation 310 may include a global positioning system (GPS) and receive a satellite signal propagating from a Global Positioning System (GPS) satellite through the GPS. The satellite signal may include the location coordinates of the vehicle 1.

The detector 320 may obtain surrounding information of the vehicle 1.

The detector 320 may include a camera 322, a radar 324 and/or a Light Detection and Ranging (LiDAR) 326.

A single or a plurality of cameras 322 may be provided. Also, the camera 322 may be mounted inside and/or outside of the main body 10 of the vehicle 1 to obtain image data. For instance, the camera 322 may include the camera 120 of FIG. 2.

A single or a plurality of radars 324 may be provided. Also, the radar 324 may be mounted inside and/or outside of the main body 10 of the vehicle 1 to obtain radar data. For instance, the radar 324 may include the radars 130, 131, 132, 133 and 134 of FIG. 2.

A single or a plurality of LiDARs 326 may be provided. Also, the LiDAR 326 may be mounted inside and/or outside of the main body 10 of the vehicle 1 to obtain LiDAR data.

The inputter 326 may include a microphone and/or a touch screen, and the like.

For example, the microphone may receive voice of a user of the vehicle 1 and change a received sound to an electrical signal.

The touch screen may receive a touch, gesture, proximity or hover input.

The outputter 340 may include a speaker and/or a display device, and the like.

The speaker may change the electrical signal to a sound and output the sound.

The display device may display a variety of content such as a text, image, video, icon and/or symbol, etc. The display device may include a touchscreen.

The above-described navigation 310, the inputter 330 and/or the outputter 340 may be included in an audio, video, navigation (AVN) device of the vehicle 1. The AVN device refers to a multimedia device where an audio, video, and/or navigation, etc., are integrated into one. The AVN device may be provided in a center fascia of the vehicle 1, without being limited thereto.

The communicator 350 may establish wireless and/or wired communication channel between the vehicle 1 and an external device such as an electronic device or an external server and support communication through the established communication channel. Also, the communicator 350 may include a communication circuit. For instance, the communicator 350 may include a wired communication module (e.g., a power line communication module) and/or a wireless communication module (e.g., a cellular communication module, a Wi-Fi communication module, a local wireless communication module, and/or a Bluetooth communication module) and may communicate with the external device using a corresponding communication module among the communication modules above.

The communicator 350 may include a communication circuit (also referred to as a transceiver) configured for performing communication among constituent components (also referred to as devices) of the vehicle 1, e.g., a controller area network (CAN) communication and/or a Local Interconnect Network (LIN) communication, and a control circuit that controls operations of the communication circuit.

The driving portion 360 includes a motor and is operated to open the door 100 using a force of the motor. The driving portion 360 may generate a rotation force of the motor in a first direction to control the door 100 to automatically be open. Also, the driving portion 360 may generate a rotation force of the motor in a second direction to control the door 100 to automatically be closed.

Furthermore, when a passenger manually opens the door 100, the driving portion 360 may generate the rotation force of the motor in the second direction to resist opening of the door 100. In the present instance, the driving portion 360 may control a magnitude of the rotation force applied to the motor and a time during which the rotation force is applied to the motor according to a command from the controller 370.

The controller 370 may control at least one other constituent component of the vehicle 1 (e.g., a device and/or a software (software program)), and perform various data processing and data operations.

The controller 370 may include a processor 372 and a memory 374.

The processor 372 may control the at least one other constituent component of the vehicle 1 and perform various data processing and data operations.

The memory 374 may store a program and/or data for processing the image data, a program and/or data for processing the radar data, and a program and/or data for the processor 372 to generate a brake signal and/or a warning signal.

The memory 374 may temporarily store the image data received from the camera 322, the radar data received from the radar 324 and/or the LiDAR data received from the LiDAR 326. Also, the memory 374 may temporarily store processing results of the image data, the radar data and the LiDAR data of the memory 374.

The memory 374 may be implemented with at least one of a non-volatile memory such as cache, read only memory (ROM), programmable read only memory (PROM), erasable programmable read only memory (EPROM), electrically erasable programmable read only memory (EEPROM) and flash memory, a volatile memory such as random access memory (RAM) and storage medium such as Hard Disk Drive (HDD) and compact disc read only memory (CD-ROM), without being limited thereto.

The controller 370 may include an image signal processor to process the image data of the camera 322, and/or a digital signal processor to process the radar data of the radar 324 and/or a micro control unit (MCU) to generate a brake signal.

The controller 370 may identify an intersection based on the map information included in the navigation information.

In an autonomous driving mode, when image information (i.e., the image data) is received from the camera 322, the controller 370 may recognize a lane of a road by image processing, and recognize the lane in which the vehicle 1 is running based on location information of the recognized lane. Also, the controller 370 may determine whether both lanes of the lane where the vehicle 1 is running are recognized, and when it is determined that both the lanes are recognized, the controller 370 may control autonomous driving based on the recognized lanes.

The controller 370 may identify objects in an image based on the image information obtained by the camera 322, compare information of the identified objects and object information stored in the memory 374, and determine whether the objects in the image are stationary or moving.

The controller 370 may identify a pedestrian walkway such as a crosswalk through the camera 120 that obtains image data of a front of the vehicle 1 among the cameras 322.

The controller 370 may identify a firefighting facility zone through the camera 120 that obtains the image data of the front of the vehicle 1, a side camera that obtains image data of sides of the vehicle 1 and/or a rear camera that obtains image data of a rear of the vehicle 1.

The controller 370 may detect objects located in front of the vehicle 1 (e.g., other vehicles, pedestrians, cyclists, curbs, guard rails, street trees, street lights, etc.) based on the image data of the camera 322 and front radar data of the first radar 130 which is a front radar.

The controller 370 may obtain location information (distance and direction) and speed information (relative speed) of the objects located in front of the vehicle 1 based on the front radar data of the front radar 130.

The controller 370 may obtain the location information (direction) and type information (e.g., information whether the object is another vehicle, pedestrian, cyclist, curb, guard rails, street tree, or street light, etc.) of the objects located in front of the vehicle 1 based on the image data of the camera 322.

The controller 370 may obtain location information (distance and direction) and speed information (relative speed) of objects located on the sides (front right, front left, rear right, and rear left sides) of the vehicle 1 based on corner radar data of the plurality of corner radars 131, 132, 133 and 134.

For instance, the controller 370 may determine a distance to collision (DTC) based on the speed information (i.e., relative speed) of objects obtained by the plurality of corner radars 131, 132, 133 and 134, and transmit a control signal to at least one of a warning device and a braking device based on a comparison result between the DTC and a distance to corner objects. Here, the warning device outputs a warning signal and the braking device controls braking of the vehicle 1.

For instance, the controller 370 may determine a time to collision (TTC) between the vehicle 1 and the corner object based on location information (relative distance) and speed information (relative speed) of the corner objects, and transmit a control signal for providing a driver with warning information to the warning device or transmit a brake signal to a braking portion, based on a comparison result between the TTC and a predetermined reference time.

The controller 370 may identify a no-stopping zone around a location where a passenger of the vehicle 1 requests to get on or off, select a safe location for stopping the vehicle 1 and provide the passenger with detailed location information.

The controller 370 may control a driving device of the vehicle 1 to enable the vehicle 1 to move based on a location of a passenger who desires to get on the vehicle 1, and also determine a stopping location of the vehicle 1 based on surrounding environment information of the passenger. For example, the controller 370 may control the vehicle 1 to be stopped at a place except for no-stopping zone (e.g., an intersection, a pedestrian walkway, a place where a fire hydrant is placed, and/or a school zone, etc.).

The controller 370 may control the driving device of the vehicle 1 to enable the vehicle 1 to move based on a destination of the passenger who gets on the vehicle 1, and determine a stopping location of the vehicle 1 based on surrounding environment information of the destination. For example, the controller 370 may control the vehicle 1 to be stopped at a place except for no-stopping zone (e.g., an intersection, a pedestrian walkway, a place where a fire hydrant is placed, and/or a school zone, etc.).

For instance, the controller 370 may identify a pattern of the pedestrian walkway and/or intersection through the front camera 120 for surround view monitor. The controller 370 may identify the pedestrian walkway and/or intersection based on information on the pedestrian walkway and/or intersection stored in the navigation information in advance.

For instance, the controller 370 may identify a fire hydrant through the front camera 120 for surround view monitor. The controller 370 may identify the fire hydrant and/or a place where the fire hydrant is placed, based on identification of a red line around the fire hydrant through the front camera 120 for surround view monitor.

For instance, the controller 370 may determine the stopping location of the vehicle 1 according to whether the stopping location is a wide street or a narrow path based on the navigation information of the navigation 310 and/or information obtained through the detector 320.

For example, when the stopping location is on the wide street, the controller 370 may determine a vehicle stand area as the stopping location of the vehicle 1, that is, a place where the passenger may get on or off, based on the map information included in the navigation information.

For example, when the stopping location is on the wide street, the controller 370 may determine any point 5m outside of the pedestrian walkway, the place where the fire hydrant is placed, and/or the intersection, as the stopping location of the vehicle 1, that is, the place where the passenger may get on or off.

For example, when the stopping location is on the narrow path, the controller 370 may determine any point 5m outside of the pedestrian walkway, the place where the fire hydrant is placed, and/or the intersection, as the stopping location of the vehicle 1, that is, the place where the passenger may get on or off.

Furthermore, when the vehicle 1 is stopped at the stopping location and the passenger desires to get off the vehicle 1, the controller 370 may determine whether the passenger may safely get off the vehicle 1 based on surrounding information of the vehicle 1 obtained through the detector 320. That is, the controller 370 may determine an accident risk due to other vehicle, motorcycle, bicycle, etc., approaching the vehicle 1. When it is determined that the passenger may safely get off the vehicle 1, the controller 370 may allow the door 100 of the vehicle 1 to be open according to the passenger's intention. When it is not determined that the passenger may safely get off the vehicle 1, the controller 370 may control the opening of the door 100 to be delayed so that the door 100 may not be easily open at once.

For instance, the controller 370 may identify an object approaching the vehicle 1 based on corner radar data of at least one of the plurality of corner radars 131, 132, 133 and 134, and predict a route of the object based on location information (distance and/or direction) and speed information (relative speed) of the object.

Also, the controller 370 may identify a stationary object located in a direction where the door 100 opens, based on the corner radar data of at least one of the plurality of corner radars 131, 132, 133 and 134, and also identify location information (distance and/or direction) of the stationary object.

The controller 370 may determine a size of an area required when the door 100 of the vehicle 1 is open or the passenger gets off the vehicle 1.

When the area required when the door 100 is open or the passenger gets off is predicted to be included in a route of an approaching object or in an area which may collide with a stationary object, the controller 370 may determine that a collision with the object may occur.

When it is identified that the passenger attempts to open the door 100 and it is determined that the collision with the object may occur, the controller 370 may determine a resistance value in the motor and control an opening time of the door 100. For example, the controller 370 may control the driving portion 360 to generate a rotation force of the motor in an opposite direction to delay full opening of the door 100.

For instance, the controller 370 may receive a requested stopping location of the vehicle 1 for the passenger to get on or off, based on a user's manipulation through the inputter 330 or reception of a signal through the communicator 350.

Also, the controller 370 may identify the navigation information output from the navigation 310 and information on a designated no-stopping zone stored in the memory 374, in response to receiving of the requested stopping location.

Also, the controller 370 may determine a stopping location of the vehicle 1 based on the navigation information and the information on the designated no-stopping zone. The controller 370 may control the driving device of the vehicle 1 to control the vehicle 1 to head to the determined stopping location.

For example, the information on the designated no-stopping zone may include information indicating that an area designated by law such as an intersection, a pedestrian walkway, a location where a fire hydrant is placed and/or a school zone, etc., is located within a predetermined distance from the vehicle.

Furthermore, when the vehicle 1 arrives at the determined stopping location, the controller 370 may control the vehicle 1 to stop by controlling a braking device of the vehicle 1.

Furthermore, when the vehicle 1 is stopped at the determined stopping location, the controller 370 may detect whether an object approaches the vehicle 1 and/or the passenger opens the door 100 based on the surrounding information obtained through the detector 320.

Furthermore, when whether the object approaches the vehicle 1 and/or the passenger opens the door 100 are detected, the controller 370 may control the driving portion 360 to generate a rotation force in a second direction opposite to the first direction. Here, the door 100 is open when a rotation force is generated in the first direction. Accordingly, the opening of the door 100 may be delayed in order not to be open at once regardless of the passenger's will.

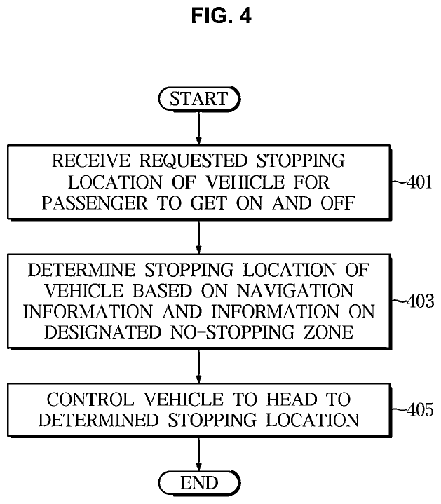

FIG. 4 is a flowchart illustrating operations of the vehicle 1 (and/or the controller 370 of the vehicle 1) according to an exemplary embodiment of the present disclosure.

The vehicle 1 may receive a requested stopping location of the vehicle 1 for a passenger to get on or off (401).

The vehicle 1 may receive the requested stopping location of the vehicle 1 for the passenger to get on or off based on a user's input through the inputter 330.

The vehicle 1 may receive the requested stopping location of the vehicle 1 for the passenger to get on or off through the communicator 350 from an external device.

The external device may be a passenger's electronic device or an application server allowing the vehicle 1 to be used. For instance, the passenger may reserve the vehicle 1 through an application provided in the passenger's electronic device, and also the requested stopping location of the vehicle 1 for getting on or off may be transmitted to the vehicle 1 through the application.

The vehicle 1 may determine a stopping location of the vehicle 1 based on navigation information of the navigation 310 and information on a designated no-stopping zone, in response to receiving of the requested stopping location of the vehicle 1 for getting on or off (403).

The vehicle 1 may control the vehicle 1 to head to the determined stopping location (405).

The information on the designated no-stopping zone include information indicating that an area such as an intersection, a pedestrian walkway, a location where a fire hydrant is placed and/or a school zone, etc., is located within a predetermined distance.

The vehicle 1 may identify whether the received requested stopping location is included in the designated no-stopping zone based on the navigation information and the information on the designated no-stopping zone.

When the received requested stopping location is included in the designated no-stopping zone, the vehicle 1 may determine at least one location outside of the designated no-stopping zone and located within a predetermined distance range from the requested stopping location, as the stopping location of the vehicle 1, based on the navigation information.

For instance, the vehicle 1 may determine a location which is the closest to the requested stopping location and does not require the passenger to cross a crosswalk among the at least one location located within the predetermined distance range from the requested stopping location, as the stopping location of the vehicle 1.

For example, when the received requested stopping location is included in the designated no-stopping zone, the vehicle 1 may transmit information on a suggestion of the determined stopping location as the stopping location of the vehicle 1 through the communicator 350, or output the information on the suggestion of the determined stopping location as the stopping location of the vehicle 1 through the outputter 340.

Accordingly, the passenger may check the stopping location of the vehicle 1 suggested by the vehicle 1, determine whether to approve the suggested stopping location of the vehicle 1, and allow corresponding information to be transmitted to the vehicle 1.

For instance, the passenger may allow approval information or disapproval information to the stopping location of the vehicle 1 suggested by the vehicle 1 to be transmitted to the vehicle 1 through the passenger's electronic device and/or an application provided in the electronic device. Furthermore, when the passenger is in the vehicle 1, the passenger may input the approval information or the disapproval information to the stopping location of the vehicle 1 suggested by the vehicle 1 through the inputter 330 of the vehicle 1.

Accordingly, the vehicle 1 may receive the approval information or the disapproval information to the stopping location suggested by the vehicle 1 through the communicator 350 or the inputter 330.

When the approval information to the stopping location suggested by the vehicle 1 is received through the communicator 350 or the inputter 330, the vehicle 1 may drive to the stopping location suggested by the vehicle 1.

Furthermore, when the disapproval information to the stopping location suggested by the vehicle 1 is received through the communicator 350 or the inputter 330, the vehicle 1 may re-determine a stopping location of the vehicle 1 based on the navigation information and/or surrounding information of the vehicle 1 obtained by the detector 320 to notify to the passenger.

In addition to the above-described embodiment of FIG. 4, the vehicle 1 may identify whether the requested stopping location is included in the designated no-stopping zone, further based on the surrounding information obtained by the detector 320.

Also, in addition to the above-described embodiment of FIG. 4, when the vehicle 1 arrives at a predetermined distance from the determined stopping location, the vehicle 1 may determine a location where the passenger is able to get on or off based on the surrounding information obtained by the detector 320.

For instance, the vehicle 1 may determine, as the location where the passenger is able to get on or off, a place which is closest to the determined stopping location and not included in an area corresponding to the information on the designated no-stopping zone to avoid a collision with other objects such as a vehicle, motorcycle, bicycle, pedestrian, etc., around the determined stopping location, based on the surrounding information obtained by the detector 320.

The vehicle 1 may transmit information on the location where the passenger is able to get on or off through the communicator 350 to the external device such as the application server or the passenger's electronic device that allows the vehicle 1 to be used, or output the information on the location where the passenger is able to get on or off through the outputter 340.

Accordingly, the passenger may check the location where the passenger is able to get on or off, determine whether to get on or off at the location determined by the vehicle 1, and allow corresponding information to be transmitted to the vehicle 1.

For example, the passenger may allow approval information or disapproval information to the location where the passenger is able to get on or off to be transmitted to the vehicle 1 through the passenger's electronic device and/or the application provided in the electronic device. Furthermore, when the passenger is in the vehicle 1, the passenger may input the approval information or the disapproval information to the location where the passenger is able to get on or off through the inputter 330 of the vehicle 1.

Accordingly, when the approval information to the location where the passenger is able to get on or off is received through the communicator 350 or the inputter 330, the vehicle 1 may control the vehicle 1 to stop at the location where the passenger is able to get on or off. Furthermore, when the disapproval information to the location where the passenger is able to get on or off is received through the communicator 350 or the inputter 330, the vehicle 1 may re-determine a location where the passenger is able to get on or off based on the surrounding information obtained by the detector 320 to notify to the passenger.

In addition to the above-described embodiment, when the vehicle 1 is stopped at the determined stopping location, the vehicle 1 may detect whether an object such as another vehicle, motorcycle, bicycle, and the like approaches the vehicle 1 based on the surrounding information obtained by the detector 320, and/or whether the passenger opens the door 100 based on information obtained by a door detector of the vehicle 1. When the approaching of the object to the vehicle 1 and the opening of the door 100 are detected, the vehicle 1 may control the vehicle 1 to delay the opening of the door 100.

For instance, when the approaching of the object to the vehicle 1 and the opening of the door 100 are detected, the vehicle 1 may control the driving portion 360 to generate a rotation force of a motor in a second direction opposite to a first direction. Here, the driving portion 360 drives the motor, and the door 100 is open by a rotation force in the first direction and is closed by the rotation force in the second direction.

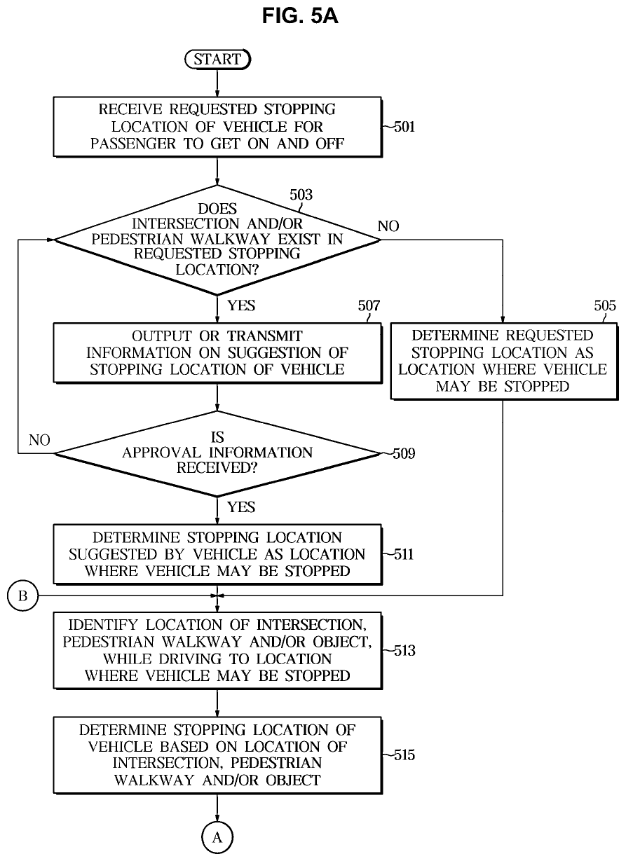

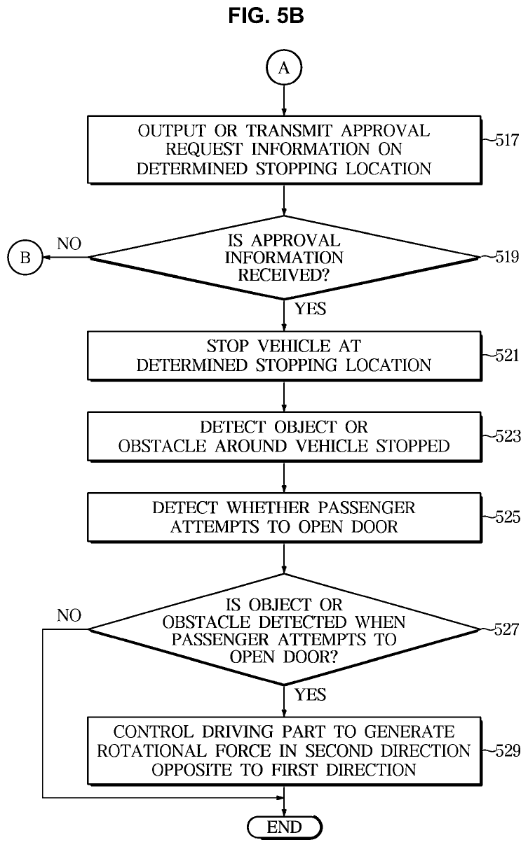

FIG. 5A and FIG. 5B are flowcharts illustrating operations of the vehicle 1 (and/or the controller 370 of the vehicle 1) according to an exemplary embodiment of the present disclosure.

The vehicle 1 may receive a requested stopping location for a passenger to get on or off through the communicator 350 or the inputter 330 of the vehicle 1 (501).

The vehicle 1 may identify whether an intersection and/or a pedestrian walkway exist in the requested stopping location based on navigation information of the navigation 310 in response to the receiving of the requested stopping location of the vehicle 1 (503).

When the intersection and/or the pedestrian walkway exist in the requested stopping location, the vehicle 1 may perform an operation 507. Otherwise, the vehicle 1 may perform an operation 505.

The vehicle 1 may determine the requested stopping location of the vehicle 1 as a location where the vehicle 1 may be stopped (505).

The vehicle 1 may output or transmit information on a suggestion of the stopping location of the vehicle 1 through the outputter 340 or the communicator 350 (507).

The vehicle 1 may identify whether approval information to the suggestion of the stopping location of the vehicle 1 is received through the inputter 330 or the communicator 350 (509).

When the approval information is received, the vehicle 1 may perform an operation 511. Otherwise, the vehicle 1 may perform the operation 507 again.

The vehicle 1 may determine the stopping location suggested by the vehicle 1 as the location where the vehicle 1 may be stopped (511).

The vehicle 1 may identify a location of the intersection, pedestrian walkway and/or object (e.g., a fire hydrant, another vehicle, motorcycle, bicycle, and/or people, etc.) while driving to the location where the vehicle 1 may be stopped (513).

The vehicle 1 may determine the stopping location of the vehicle 1 based on the location of the intersection, the pedestrian walkway and/or the object (515).

The vehicle 1 may output or transmit approval request information to the determined stopping location through the outputter 340 or the communicator 350 (517).

The vehicle 1 may identify whether approval information to the determined stopping location is received (519).

When the approval information to the determined stopping location is received, the vehicle 1 may perform an operation 521. Otherwise, the vehicle 1 may perform the operation 513 again.

The vehicle 1 may be stopped at the determined stopping location (521).

The vehicle 1 may detect an object or an obstacle around the vehicle 1 stopped (523).

The object indicates a moving object based on the vehicle 1, such as another vehicle, motorcycle, pedestrian, and the like. Also, the obstacle indicates a stationary object based on the vehicle 1, such as a wall, another parked vehicle, a structure, etc.

The vehicle 1 may detect whether the passenger attempts to open the door 100 (525).

The vehicle 1 may detect whether the passenger attempts to open the door 100 at a passenger seat or a rear seat to get off the vehicle 1 through a door detector, etc., after stopped.

The vehicle 1 may identify whether the object or the obstacle is detected when the passenger attempts to open the door 100 (527).

When the object or the obstacle is detected at the time of attempting to open the door 100, the vehicle 1 may perform an operation 529. Otherwise, the vehicle 1 may end the operations according to an exemplary embodiment of the present disclosure.

When the object or the obstacle is detected, the vehicle 1 may perform an operation for preventing an accident likely to occur when getting off.

By contrast, when no object or obstacle is detected, the passenger is able to get off, and thus the vehicle 1 may open the door 100 as intended by the passenger without applying a rotation force to the motor of the driving portion 360.

The vehicle 1 may control the driving portion 360 so that a rotation force is generated in a second direction opposite to a first direction (529). Here, the door 100 is open when the rotation force is generated in the first direction thereof.

When the approaching of the object to the vehicle 1 and the opening of the door 100 by the passenger are detected, the vehicle 1 may control the driving portion 360 so that the rotation force in the opposite direction is generated to delay a full opening of the door 100 or prevent the door 100 from opening.

For instance, the vehicle 1 may prevent the door 100 from opening at once by applying the rotation force to the motor in the second direction opposite to the first direction, or prevent the door 100 from opening together with a warning sign through the outputter 340. In the present instance, the controller 370 may predict a location where the object approaches the vehicle 1 through the detector 320 and control any one driving portion 360 among a plurality of doors 100 based on the predicted location.

Also, the vehicle 1 may control the driving portion 360 so that the rotation force is generated in the second direction for a predetermined time period. The predetermined time period refers to a general time period sufficient for the object to pass by the vehicle 1 from the rear. For example, the predetermined time period may be 1 to 5 seconds. In addition to the predetermined time period, a time period during which the rotation force in the second direction is applied may be applied by determining a time period that the object passes by the vehicle 1.

Meanwhile, the vehicle 1 may control the driving portion 360 based on a distance between the vehicle 1 and a stationary obstacle, in addition to the object approaching from the rear. For example, when the door 100 may not be fully open due to an obstacle such as a wall located on a right or left side of the vehicle 1, the vehicle 1 may apply a resistance to the door 100 to prevent a collision between the door 100 and the obstacle.

The vehicle 1 may detect a stationary obstacle around the vehicle 1 through the detector 320 and identify the distance between the vehicle 1 and an obstacle. In the present instance, the obstacle refers to the stationary object on the right or left side of the vehicle 1. When the distance between the vehicle 1 and the obstacle is equal to or less than a predetermined distance, the vehicle 1 may control the driving portion 360 to generate the rotation force in the second direction thereof. Here, the controller 370 may control a magnitude of the rotation force in the second direction to be inversely proportional to the distance. Accordingly, when the obstacle is close, a large resistance may be applied to the door 100, and when the obstacle is relatively distant, a small resistance may be applied to the door 100.

Also, in addition to the above-described embodiment, when the object or the obstacle is detected at the time of attempting to open the door 100, information notifying a collision risk with the object or obstacle may be output through the outputter 340 so that a driver and the passenger may recognize the risk.

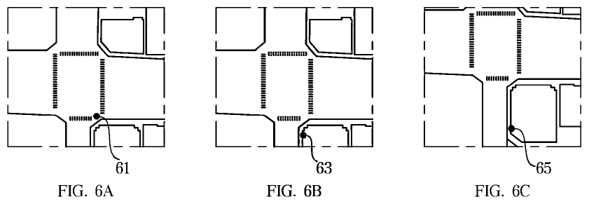

According to the exemplary embodiments described above, as shown in FIG. 6A, FIG. 6B and FIG. 6C are, the vehicle 1 may suggest the stopping location of the vehicle 1 for the passenger to get on or off.

FIG. 6A, FIG. 6B and FIG. 6C are diagrams illustrating operations of the vehicle 1 (and/or the controller 370 of the vehicle 1) according to an exemplary embodiment of the present disclosure.

Referring to FIG. 6A, when receiving a requested stopping location 61 for a passenger to get on or off, the vehicle 1 may identify whether the requested stopping location 61 for the passenger to get on or off the vehicle 1 is on a crosswalk, based on map information of the navigation 310, as shown in FIG. 6A.

Based on the identification of whether the requested stopping location 61 is on the crosswalk, the vehicle 1 may suggest any point, which is adjacent to the requested stopping location 61 and easy for the passenger to move, as shown in FIG. 6B, to the passenger as a stopping location 63 of the vehicle 1 based on the map information of the navigation 310.

For instance, the vehicle 1 may suggest, to the passenger, a location which is adjacent to the requested stopping location 61, not included in a designated no-stopping zone, and where the passenger is not required to cross the crosswalk, as the stopping location 63 of the vehicle 1.

When approval information to the suggestion for the stopping location 63 is received, the vehicle 1 may head to the stopping location 63 suggested to the passenger.

When arriving at a predetermined distance from the suggested stopping location 63, the vehicle 1 may identify again whether the suggest stopping location 63 is included in the designated no-stopping zone, whether an object such as another vehicle, motorcycle, bicycle, people, etc., exists in the suggested stopping location 63, and whether the vehicle 1 may not be stopped in the suggested stopping location 63 due to a construction, and the like, through the detector 320.

When it is identified through the detector 320 that the vehicle 1 may not be stopped in the suggested stopping location 63 due to a fire hydrant which is included in the designated no-stopping zone, the vehicle 1 may re-determine a stopping location of the vehicle 1 based on the map information of the navigation 310 and/or surrounding information obtained by the detector 320, as shown in FIG. 6C.

The vehicle 1 may provide the passenger with information on the re-determined stopping location 65, and may be stopped at the re-determined stopping location 65 based on the passenger's approval.

The vehicle 1 may identify whether the door 100 may be open after stopped, and control the opening of the door 100 for the passenger to get on or off.

For instance, when an object approaching a door to be open is identified after stopped, the vehicle 1 may control the door 100 to be open slowly.

Furthermore, when it is determined that a space on a side of the door to be open is narrow after stopped, e.g., when it is determined that the door 100 may not be open due to an object located on the side of the door to be open, the vehicle 1 may move slightly so that the door 100 is open.

Meanwhile, the vehicle 1 according to the exemplary embodiments above may be a driverless taxi, that is, an unmanned vehicle configured for autonomous driving. Accordingly, the vehicle 1 may move to a location of the passenger by autonomous driving.

Also, the vehicle 1 according to the exemplary embodiments above may induce a vehicle fare payment to be completed before the passenger gets off through a resistance of the door 100. When it is detected that the passenger attempts to get off without paying a vehicle fare, the vehicle 1 may control the driving portion 360 to generate a rotation force in the second direction opposite to the first direction.

As is apparent from the above, according to the exemplary embodiments of the present disclosure, the vehicle and the control method thereof can allow a passenger to safely get on or off the vehicle without a risk of a traffic accident, and thus a likelihood of traffic accident occurring when getting on or off may be reduced.

According to the exemplary embodiments of the present disclosure, the vehicle and the control method thereof can minimize obstruction to nearby vehicle's driving and pedestrian's walking due to stopping or parking and/or getting on or off, by facilitating the vehicle to stop outside a no-parking/stopping zone.

According to the exemplary embodiments of the present disclosure, the vehicle and the control method thereof may be applied to a driverless taxi, etc., and provide a technology for driverless taxi with an improved performance and safety, compared to a conventional driverless taxi, and thus a user's anxiety about a driverless taxi may be reduced.

Embodiments can thus be implemented through computer readable code/instructions in/on a medium, e.g., a computer readable medium, to control at least one processing element to implement any above described exemplary embodiment of the present disclosure. The medium can correspond to any medium/media permitting the storing and/or transmission of the computer readable code.

The computer-readable code may be recorded on a medium or transmitted through the Internet. The medium may include read only memory (ROM), random access memory (RAM), magnetic tapes, magnetic disks, flash memories, and optical recording medium.

In various exemplary embodiments of the present disclosure, the control device may be implemented in a form of hardware or software, or may be implemented in a combination of hardware and software.

Furthermore, the terms such as “˜unit”, “˜module”, etc. Included in the specification mean units for processing at least one function or operation, which may be implemented by hardware, software, or a combination thereof.

For convenience in explanation and accurate definition in the appended claims, the terms “˜upper”, “˜lower”, “˜inner”, “˜outer”, “˜up”, “˜down”, “˜upwards”, “˜downwards”, “˜front”, “˜rear”, “˜back”, “˜inside”, “˜outside”, “˜inwardly”, “˜outwardly”, “˜interior”, “˜exterior”, “˜internal”, “˜external”, “˜forwards”, and “˜backwards” are used to describe features of the exemplary embodiments with reference to the positions of such features as displayed in the figures. It will be further understood that the term “˜connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle, comprising:
a navigation configured to output navigation information; and
a controller configured to receive a requested stopping location of the vehicle for a passenger to get on or off, to determine a stopping location of the vehicle based on the navigation information and information on a designated no-stopping zone, in response to the receiving of the requested stopping location, and to control the vehicle to head to the determined stopping location.

2. The vehicle of claim 1,
wherein the controller is configured to identify whether the requested stopping location is included in the designated no-stopping zone based on the navigation information and the information on the designated no-stopping zone, and
wherein, when the requested stopping location is included in the designated no-stopping zone, the controller is configured to determine at least one location outside of the designated no-stopping zone and located within a predetermined distance range from the requested stopping location, as the stopping location of the vehicle, based on the navigation information.

3. The vehicle of claim 2, wherein, when the requested stopping location is included in the designated no-stopping zone, the controller is configured:
to control a communicator of the vehicle to transmit information on a suggestion of the determined stopping location as the stopping location of the vehicle, or to control an outputter of the vehicle to output the information on the suggestion of the stopping location of the vehicle as the determined stopping location, and
to control the vehicle to head to the determined stopping location according to reception of approval information to the suggestion of the stopping location of the vehicle through the communicator or an inputter of the vehicle.

4. The vehicle of claim 2, wherein the controller is configured to determine the requested stopping location as the stopping location of the vehicle, when the requested stopping location is not included in the designated no-stopping zone.

5. The vehicle of claim 2, further including:
a detector configured to obtain surrounding information of the vehicle,
wherein the controller is configured to identify whether the requested stopping location is included in the designated no-stopping zone, further based on the surrounding information obtained through the detector.

6. The vehicle of claim 5, wherein the controller is configured:
to determine a location where the passenger is able to get on or off the vehicle based on the surrounding information obtained through the detector, when the vehicle arrives at a predetermined distance from the determined stopping location, and
to control the communicator of the vehicle to transmit information on the location where the passenger is able to get on or off the vehicle, or to control an outputter of the vehicle to output the information on the location where the passenger is able to get on or off the vehicle.

7. The vehicle of claim 6, wherein the controller is configured to control the vehicle to stop at the location where the passenger is able to get on or off the vehicle, according to reception of approval information to the information on the location where the passenger is able to get on or off the vehicle through the communicator or an inputter of the vehicle.

8. The vehicle of claim 6, wherein the controller is configured to re-determine the location where the passenger is able to get on or off the vehicle based on the surrounding information obtained through the detector and a reception of disapproval information to the location where the passenger is able to get on or off the vehicle through the communicator or an inputter of the vehicle.

9. The vehicle of claim 5, wherein the detector includes at least one of a camera, a radar and a Light Detection and Ranging (LiDAR).

10. The vehicle of claim 1, further including:
a detector configured to obtain surrounding information of the vehicle; and
a driving portion configured to allow a door of the vehicle to be open by a rotation force of a motor in a first direction,
wherein, when the vehicle is stopped at the determined stopping location, the controller is configured to detect whether an object approaches the vehicle and whether the passenger opens the door, based on the surrounding information obtained through the detector, and
wherein, when the approaching of the object to the vehicle and the opening of the door are detected, the controller is configured to control the driving portion to generate a rotation force in a second direction opposite to the first direction thereof.

11. The vehicle of claim 1, wherein the information on the designated no-stopping zone includes information indicating that at least one of an intersection, a pedestrian walkway, a location where a fire hydrant is placed, or a school zone is located within a predetermined distance from the vehicle.

12. A method of controlling a vehicle, the method comprising:
receiving, by a controller, a requested stopping location of the vehicle for a passenger to get on or off,
determining, by the controller, a stopping location of the vehicle based on navigation information of the vehicle and information on a designated no-stopping zone, in response to the receiving of the requested stopping location, and
controlling, by the controller, the vehicle to head to the determined stopping location.

13. The method of claim 12, wherein the determining of the stopping location of the vehicle includes:
identifying whether the requested stopping location is included in the designated no-stopping zone based on the navigation information and the information on the designated no-stopping zone, and
when the requested stopping location is included in the designated no-stopping zone, determining at least one location outside of the designated no-stopping zone and located within a predetermined distance range from the requested stopping location, as the stopping location of the vehicle, based on the navigation information.

14. The method of claim 13,
wherein the determining of the stopping location of the vehicle includes, when the requested stopping location is included in the designated no-stopping zone, transmitting information on a suggestion of the determined stopping location as the stopping location of the vehicle to an external device, or outputting the information on the suggestion of the determined stopping location as the stopping location of the vehicle, and
wherein the controlling of the vehicle to head to the determined stopping location is performed according to reception of approval information to the suggestion of the stopping location of the vehicle.

15. The method of claim 13, wherein the determining of the stopping location of the vehicle includes:
determining the requested stopping location as the stopping location of the vehicle, when the requested stopping location is not included in the designated no-stopping zone.

16. The method of claim 13, wherein the identifying of whether the requested stopping location is included in the designated no-stopping zone is performed further based on surrounding information of the vehicle, the surrounding information being obtained through a detector that obtains the surrounding information of the vehicle.

17. The method of claim 16, further including:
determining, by the controller, a location where the passenger is able to get on or off the vehicle based on the surrounding information obtained through the detector, when the vehicle arrives at a predetermined distance from the determined stopping location, and
transmitting, by the controller, information on the location where the passenger is able to get on or off the vehicle to the external device, or outputting the information on the location where the passenger is able to get on or off the vehicle.

18. The method of claim 17, further including:
controlling, by the controller, the vehicle to stop at the location where the passenger is able to get on or off the vehicle, according to reception of approval information to the information on the location where the passenger is able to get on or off the vehicle.

19. The method of claim 17, further including:
re-determining, by the controller, the location where the passenger is able to get on or off the vehicle, according to the surrounding information obtained through the detector and reception of disapproval information to the location where the passenger is able to get on or off the vehicle.

20. The method of claim 12, further including:
when the vehicle is stopped at the determined stopping location, determining, by the controller, whether an object approaches the vehicle and whether the passenger opens a door of the vehicle, based on surrounding information obtained through a detector, and
when the approaching of the object to the vehicle and the opening of the door are detected, controlling, by the controller, a rotation force of a motor to be generated in a second direction opposite to a first direction, the door being open by a rotation force of the motor in the first direction.
